(19) United States
(12) Patent Application Publication
(10) Pub. No.: US 2023/0288632 A1
(43) Pub. Date: Sep. 14, 2023

(54) FIBER OPTIC CONNECTOR INSERTION AND EXTRACTION TOOLS HAVING MULTIPLE TIP GEOMETRIES

(71) Applicant: Hubbell Incorporated, Shelton, CT (US)

(72) Inventors: Tadeusz Zagula, Newington, CT (US); Brian Bourgoin, East Haddam, CT (US)

(73) Assignee: Hubbell Incorporated, Shelton, CT (US)

(21) Appl. No.: 18/180,820

(22) Filed: Mar. 8, 2023

Related U.S. Application Data
(60) Provisional application No. 63/317,802, filed on Mar. 8, 2022.

(51) Int. Cl. G02B 6/02; G02B 6/38

(52) U.S. Cl. CPC G02B 6/02209; G02B 6/3855; G02B 6/387; G02B 6/3897; G02B 6/3898

(57) ABSTRACT

An insertion and extraction tool for a fiber optic connector is provided. The tool includes a first frame member, second frame member, and a pivot connection. The pivot connection secures the first and second frame members to one another for movement between an open position and a closed position. The frame members define tips at one side of the pivot connection and handles at an opposite side of the pivot connection. The frame members, at least at the tips, have a cross sectional width equal to or smaller than the fiber optic connector. The frame members are configured so that the tips define a plurality of discrete gripping regions.

### CROSS REFERENCE TO RELATED APPLICATIONS

This application claims benefit of US Provisional Application 63/317,802 filed 8 Mar. 2022, the entire contents of which are incorporated herein by reference.

### BACKGROUND

### 1. Field of the Invention

The present disclosure is related to insertion and extraction tools for fiber optic connectors. More particularly, present disclosure is related to insertion and extraction tools having multiple tip geometries.

### 2. Description of Related Art

Traditional fiber optic cables have connectors that are removed from the panel bulkhead by depressing the lock tab on the connector, which allows the connector to unclip from the bulkhead. Current tools are designed to clip onto the locking connector and sometimes depress a locking tab so the connector can be removed from the bulkhead. Traditionally, a technician would manually insert or remove the locking connectors by hand - or using a tool that could apply the necessary pressure to the lock tab.

Recently, fiber optic cables have been developed with connectors that allow for increased connection density at the termination point. One such new connector allows for removal from the panel bulkhead by simply pulling on the connector at the strain relief or connector housing. In these connectors, there is no external locking tab actuation required for removal and therefore can have a much smaller width than traditional connectors, which allows for higher connection density.

It has been found by the present disclosure that the density at many termination points has reached a level where the spacing can make removal by hand difficult. Moreover, it has been found by the present disclosure that the tools configured for traditional locking connectors are not suitable for use with the newer connectors.

Accordingly, it has been determined by the present disclosure that there is a need for connector insertion and extraction tools that overcome, alleviate, and/or mitigate one or more of the aforementioned and other deleterious effects of the prior art.

### SUMMARY

The tool according to the present disclosure has a narrow cross section to allow the tips to fit between connectors installed on a panel. In some embodiments, the tips can be about the same width as a fiber optic connector, so it can be used on a densely packed panel bulkhead and insert or extract a single connector without interfering with the adjacent connectors.

The keyed tip geometry allows the end user to work with various connector and connector boot shapes and provide an interlocking grip when clamped. The tip advantageously allows the installer to grip the connector boot and either pull to remove or push to install the connector - using a combination of the pressure created friction as well as the geometry interlocking features.

The tool can include two frame members with a center pivot connection. In some embodiments, a torsion spring can act to bias the frame members to an open position such that the end user squeezes against the spring pressure to clamp the connector at the tip. The frame members can have and an integrated open stop to prevent the tool from opening too far so the handles are always within the ergonomic reach of an average hand. The tool can include a stowage latch configured to keep the handle closed, overriding the spring force. The frame members can also have an integrated closed stop to prevent overtravel to the closed position if the end user applies too much hand force. In some embodiments, the integrated closed stop can prevent the tips from contacting one another, which can prevent damage to the tips if the user over compress the handles. The handles can have a length and/or shape — such as an angled shape — to allow the end user to use the tips to access a connector in the panel with sufficient extension and/or clearance to avoid interference with the other cables and connectors in the panel.

The tool of the present disclosure is a narrow tip insertion and extraction tool that allows access into tight cable panels. The tips have multiple geometry integrated thereon tip to key into different connector designs. The tool frames with center pivot and, in some embodiments, one oe more of spring-loaded action, closed stops, and open stops.

An insertion and extraction tool for a fiber optic connector is provided. The tool includes a first frame member, second frame member, and a pivot connection. The pivot connection secures the first and second frame members to one another for movement between an open position and a closed position. The frame members define tips at one side of the pivot connection and handles at an opposite side of the pivot connection. The frame members, at least at the tips, have a cross sectional width equal to or smaller than the fiber optic connector. The frame members are configured so that the tips define a plurality of discrete gripping regions.

In some embodiments either alone or together with any one or more of the aforementioned and/or after-mentioned embodiments, each of the plurality of discrete gripping regions is configured to pull to extract and push to install the fiber optic connector.

In some embodiments either alone or together with any one or more of the aforementioned and/or after-mentioned embodiments, the plurality of discrete gripping regions include three regions.

In some embodiments either alone or together with any one or more of the aforementioned and/or after-mentioned embodiments, at least one the plurality of discrete gripping regions has a surface of increased friction.

In some embodiments either alone or together with any one or more of the aforementioned and/or after-mentioned embodiments, at least one the plurality of discrete gripping regions has a shoulder formed by a change in dimensions of the first and second frame members at the tips.

In some embodiments either alone or together with any one or more of the aforementioned and/or after-mentioned embodiments, the tool further includes a biasing member that normally biases the tips to a predetermined position.

In some embodiments either alone or together with any one or more of the aforementioned and/or after-mentioned embodiments, the biasing member is a torsion spring that normally biases the tips to the open position.

In some embodiments either alone or together with any one or more of the aforementioned and/or after-mentioned embodiments, the tool further includes a first stopping feature that defines the closed position, wherein the tips do not contact one another in the closed position.

In some embodiments either alone or together with any one or more of the aforementioned and/or after-mentioned embodiments, the tool further includes a second stopping feature that defines the open position.

In some embodiments either alone or together with any one or more of the aforementioned and/or after-mentioned embodiments, the tool further includes a latch configured to secure the first and second frame members in the closed position.

In some embodiments either alone or together with any one or more of the aforementioned and/or after-mentioned embodiments, the latch is configured as the second stopping feature.

In some embodiments either alone or together with any one or more of the aforementioned and/or after-mentioned embodiments, the cross sectional width is between 0.01625 inches and 0.25 inches.

In some embodiments either alone or together with any one or more of the aforementioned and/or after-mentioned embodiments, the cross sectional width is between 0.03125 inches and 0.20 inches.

In some embodiments either alone or together with any one or more of the aforementioned and/or after-mentioned embodiments, the tool further includes a coating on the handles.

In some embodiments either alone or together with any one or more of the aforementioned and/or after-mentioned embodiments, the tool further includes a latch configured to secure the first and second frame members in the closed position.

An insertion and extraction tool for a fiber optic connector is provided. The tool includes a first frame member, second frame member, and a pivot connection. The pivot connection secures the first and second frame members to one another for movement between an open position and a closed position. The frame members define tips at one side of the pivot connection. The tips defining a plurality of discrete gripping region and each of the plurality of discrete gripping regions is configured to pull to extract and push to install the fiber optic connector.

In some embodiments either alone or together with any one or more of the aforementioned and/or after-mentioned embodiments, the plurality of discrete gripping regions includes three regions.

In some embodiments either alone or together with any one or more of the aforementioned and/or after-mentioned embodiments, the tool further includes a biasing member that normally biases the tips to the open position.

An insertion and extraction tool for a fiber optic connector is provided. The tool includes a first frame member, second frame member, a pivot connection, and a biasing member. The pivot connection secures the first and second frame members to one another for movement between an open position and a closed position. The biasing member normally biases the tips to the open position. The frame members define tips at one side of the pivot connection and handles at an opposite side of the pivot connection. The frame members, at least at the tips, have a cross sectional width between 0.03125 inches and 0.20 inches. The frame members are configured so that the tips define a plurality of discrete gripping regions and each of the plurality of discrete gripping regions is configured to pull to extract and push to install the fiber optic connector.

In some embodiments either alone or together with any one or more of the aforementioned and/or after-mentioned embodiments, the plurality of discrete gripping regions is three regions.

The above-described and other features and advantages of the present disclosure will be appreciated and understood by those skilled in the art from the following detailed description, drawings, and appended claims.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a first side perspective view of an insertion and extraction tool according to the present disclosure;

FIG. 2 is a second, opposite side perspective view of the tool of FIG. 1;

FIG. 3 a side view of the tool of FIG. 1 shown in an open position;

FIG. 4 a side view of the tool of FIG. 1 shown in a closed position;

FIG. 5 is a top view of the tool of FIG. 1;

FIG. 6 is a side view of the tool of FIG. 1 in use with a first type of connector;

FIG. 7 is a side view of the tool of FIG. 1 in use with a second type of connector; and

FIG. 8 is a side view of the tool of FIG. 1 in use with a third type of connector.

### DETAILED DESCRIPTION

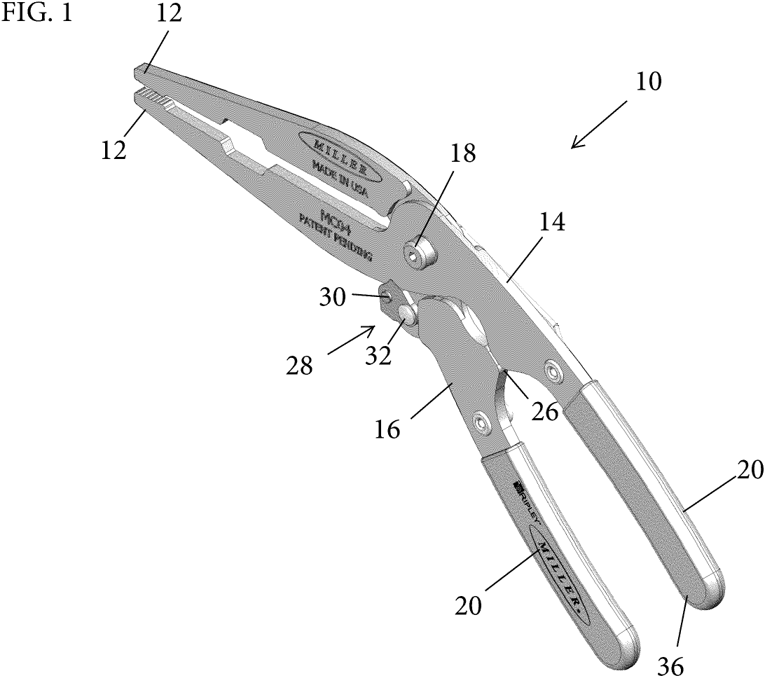

Referring to the drawings and with particular reference to FIG. 1, an exemplary embodiment of an insertion and extraction tool according to the present disclosure is shown and is generally referred to by reference numeral 10. Advantageously, tool 10 is configured with tips 12 having a narrow cross section and multiple geometries, which allowing the tool to find use with fiber optic cable connections with high connection density and having a wide range of connectors.

Tool 10 according to the present invention has a narrow cross section to allow the tip to fit between connectors installed on a panel. Tool 10 is, at least at tips 12, about the same width as a fiber optic connector, so it can be used on a densely packed panel bulkhead and insert or extract a single connector without interfering with the adjacent connectors.

Tips 12 have a geometry that allows the end user to work with various connector and connector boot shapes and provide an interlocking grip when clamped. Tips 12 are configured to allow the installer to grip the connector boot and either pull to remove or push to install the connector - using a combination of the pressure created friction as well as the geometry interlocking features. In this manner, tool 10 can be used for inserting a connector into the corresponding jack or for removing the connector from the jack.

Tool 10 is described in more detail with simultaneous reference to FIGS. 1-5.

Tool 10 includes a first frame member 14 and a second frame member 16 that are secured to one another at a pivot connection 18. Frame members 14, 16 each include tip 12 at one side of pivot connection 18 and each include handle 20 on the opposite side of the pivot connection. Thus, a user can pivot frame members 14, 16 about pivot connection 18 by manual manipulation of handles 20 towards/away from one another to cause movement of tips 12 towards/away from one another, respectively, in a known manner.

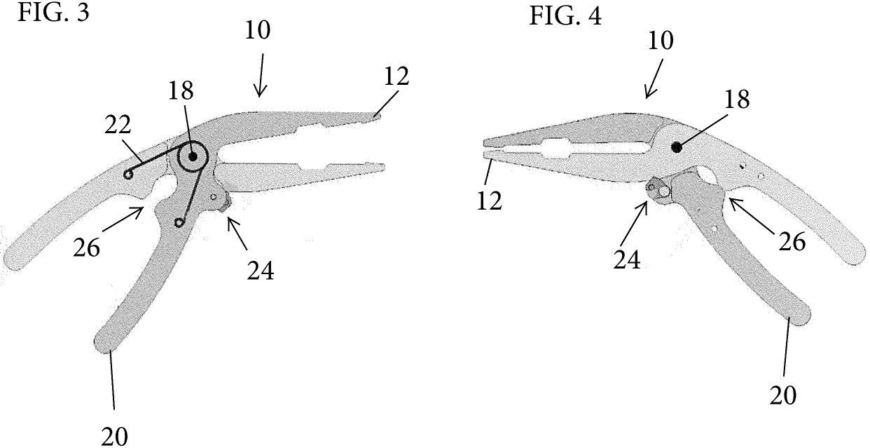

In some embodiments, tool 10 can include a biasing member 22 configured to normally bias the tool a desired position. In the illustrated embodiment, biasing member 22 is shown as a torsion spring configured and positioned to normally bias frame members 14, 16 about pivot connection 18 so that tool 10 is an open position (FIG. 3). In the open position, tips 12 and handles 20 are open or spaced apart from one another.

Further, the user can apply pressure to handles 20 to overcome the force of biasing member 22 causing frame members 14, 16 to move about pivot connection 18 so that tool 10 is a closed position (FIG. 4). In the open position, tips 12 and handles 20 are closed or proximate one another.

It should be recognized that biasing member 22 is described as a torsion spring and described normally biasing tool 10 to its open position. Of course, it is contemplated by the present disclosure for biasing member 22 to be any member capable of normally biasing tool 10 to either the open or the closed position. For example, it is contemplated by the present disclosure for biasing member 22 to be a torsion spring, extension spring, compression spring, leaf spring, clock spring, and others.

Tool 10 can include one or more stopping features to limit the travel of frame members 14, 16 with respect to one another about pivot connection 18.

For example, tool 10 can have a first stopping feature 24 that defines the open position (FIG. 3). In the illustrated embodiment, first stopping feature 24 is shown as a protrusion defined on frame member 16 and positioned to the side of pivot connection 14 closest to tips 12. In the open position, first stopping feature 24 interferes with or contacts a portion of frame member 14 to define the open-most position. First stopping feature 24 can be integrally formed with (i.e., formed as one piece) or connected to first frame member 14, second frame member 16, or both frame members.

In other examples either alone or in combination with first stopping feature 24, tool 10 can have a second stopping feature 26 that defines the closed position (FIG. 4). In the illustrated embodiment, second stopping feature 26 is shown as a protrusion defined on frame members 14, 16 to the side of pivot connection 14 closest to tips 12. In the open position, second stopping features 26 interfere with or contacts one another to define the closed-most position. Second stopping feature 26 can be integrally formed with (i.e., formed as one piece) or connected to first frame member 14, second frame member 16, or both frame members.

In some embodiments, tool 10 is configured so that second stopping features 26 prevent contact of tips 12 in the closed position. Simply stated, second stopping features 26 can prevent tool 10 from overtravel if the end user applies too much hand force to handles 20. It has been determined by the present disclosure that the narrow width of tips 12, combined with the elongated nature of the tips and the mechanical advantage provided by handles 20 can damage the tips of overtravel to a point where the tips contact one another occurs.

Tool 10 can, in embodiments having biasing member 22, can include a latch 28. Latch 28 can be configured to secure tool 10 in one or more desired positions such as the closed position, the open position, or any position therebetween. In the illustrated embodiment, latch 28 is configured to secure frame members 14, 16 rotated around pivot connection 18 to the closed position (FIG. 4). Here, latch 28 has a locking member 30 that moves about a pin 32.

Once tool 10 is moved by application of force to handles 20 to overcome the force of biasing member 22 so that frame members 14, 16 rotate around pivot connection 18 to the closed position, locking member 30 can be moved about pin 32 into an interference position that prevents the biasing member from returning the frame members to the open position. In this state, the biasing member 22 provides pressure to handles 14, 16 against locking member 30 to ensure the tool remains in the closed position.

When use of tool 10 is desired, the user can apply force to handles 20 to overcome the force of biasing member 22 and rotate frame members 14, 16 pivot connection 18 to disengage locking member 30 from the frame members and allow the locking member to be moved about pin 32 away from the interference position, which allows the biasing member to return the frame members to the normally open position.

In some embodiments, latch 28 when not preventing tool 10 from moving to the open position can also function as the first stopping member 24 discussed above.

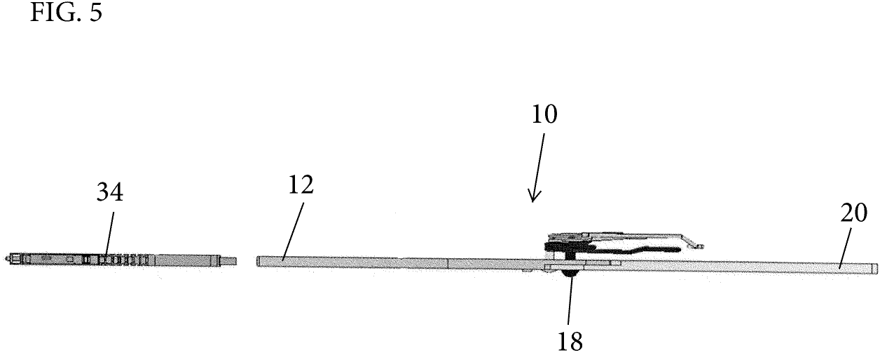

As noted above and described in more detail with particular reference to FIG. 5, tool 10 is configured with a narrow cross section, which allow the tool to find use with fiber optic cable connections with high connection density. Tool 10 is configured so that at least tips 12 have a width equal to or more narrow then the connector.

In FIG. 5, tool 10 is shown with respect to a connector 34 so that the width of tips 12 can be seen with respect to the connector. In some embodiments, tool 10 is configured so that at least tips 12 have a width of between 0.01625 inches and 0.25 inches, more preferably between 0.03125 inches and 0.20 inches, with 0.125 inches being most preferred.

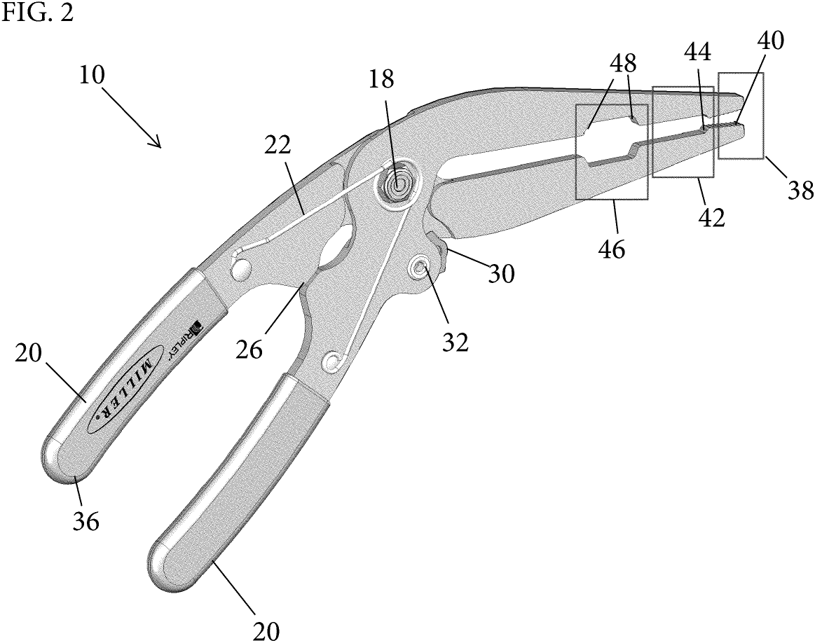

While tool 10 is described as having a narrow cross section to allow for insertion and extraction of connectors of high connection density, it is contemplated by the present disclosure for frame members 14, 16 to have the narrow cross section at tips 12 only. For example, it is contemplated for tool 10 to be configured such that handles 20 have a wider cross section than tips 12. For example, tool 10 can be configured with handles 20 that are wider than tips 12 by forming frame members 14, 16 with different widths and/or by coating handles 20 after formation of the frame members. Tool 10 is shown in FIGS. 1-2 having a coating 36 on handles 20 and is shown in FIG. 5 where tips 12 and handles 20 have the same cross section or width.

As also noted above and with particle reference to FIG. 2, tool 10 is configured so that tips 12 have a geometry that allows the end user to work with various connector types and connector boot shapes and provide an interlocking grip when clamped. In FIG. 2, it can be seen that tips 12 have a plurality of discrete gripping regions.

In some embodiments, tool 10 includes tips 12 with a first gripping region 38. In the illustrated embodiment, first gripping region 38 defined by a surface of increased friction 40 defined, for example, by knurling. In this manner, first gripping region 38 can positively engage one or more portions of the connector via friction.

In some embodiments, tool 10 includes tips 12 with a second gripping region 42. In the illustrated embodiment, second gripping region 42 is defined by a shoulder 44 formed by a change in dimensions of tips 12. In this manner, second gripping region 42 can positively engage one or more corresponding changes in dimension of the connector.

In some embodiments, tool 10 includes tips 12 with a third gripping region 46. In the illustrated embodiment, third gripping region 46 is defined by a pair of shoulders 48 formed by multiple changes in dimensions of tips 12. In this manner, third gripping region 46 can positively engage corresponding changes in dimension of the connector.

The geometry of tips 12 provide tool 10 with a plurality of discrete gripping regions 38, 42, 46 that can positively engage features of different types of connectors.

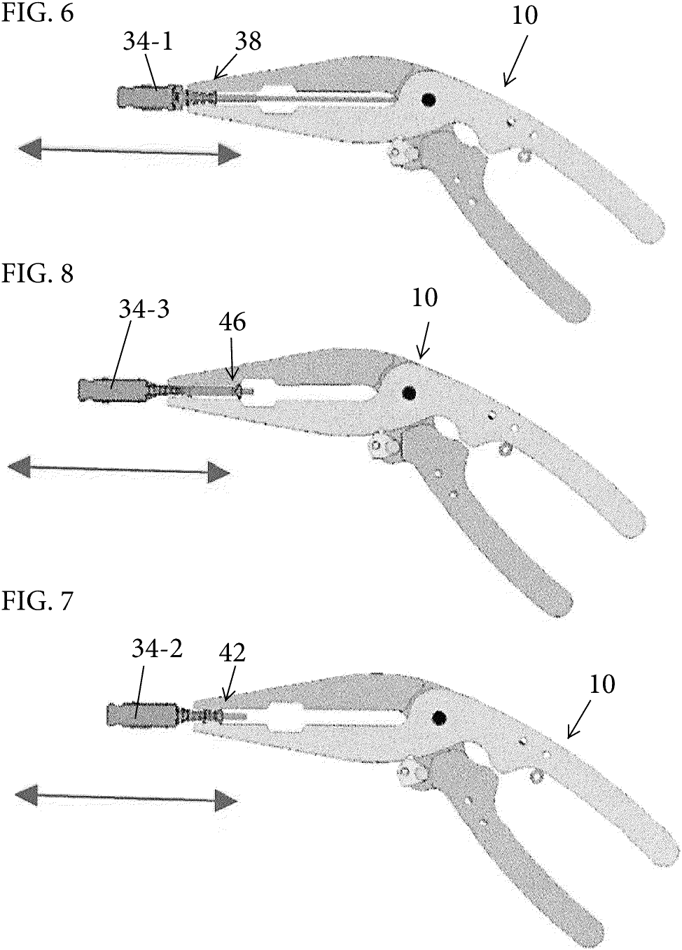

First, tool 10 is shown in FIG. 6 with first gripping region 38 engaged with a first connector type 34-1 so as to allow installation and/or extraction of that connector type. Next, tool 10 is shown in FIG. 7 with second gripping region 42 engaged with a second connector type 34-2 so as to allow installation and/or extraction of that connector type. Finally, tool 10 is shown in FIG. 8 with third gripping region 46 engaged with a third connector type 34-3 so as to allow installation and/or extraction of that connector type.

Thus, tool 10 is advantageously configured with tips 12 that allow the installer to grip the connector boot and either pull to extract or push to install the connector - using one or more of the geometric features. In this manner, tool 10 can be used for inserting a connector into the corresponding jack or for extracting the connector from the jack.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### PARTS LIST

insertion and extraction tool 10
tips 12
first frame member 14
second frame member 16
pivot connection 18
handles 20
biasing member 22
first stopping feature 24
second stopping feature 26
latch 28
locking member 30
pin 32
connector 34
coating 36
first gripping region 38
surface of increased friction 40
second gripping region 42
shoulder 44
third gripping region 46
shoulders 48

What is claimed is:

1. An insertion and extraction tool for a fiber optic connector, comprising:
a first frame member;
second frame member; and
a pivot connection securing the first and second frame members to one another for movement between an open position and a closed position,
the first and second frame members defining tips at one side of the pivot connection and handles at an opposite side of the pivot connection,
wherein the first and second frame members at least at the tips have a cross sectional width equal to or smaller than the fiber optic connector, and
wherein the first and second frame members are configured so that the tips define a plurality of discrete gripping regions.

2. The tool of claim 1, wherein each of the plurality of discrete gripping regions is configured to pull to extract and push to install the fiber optic connector.

3. The tool of claim 2, wherein the plurality of discrete gripping regions comprises three regions.

4. The tool of claim 2, wherein at least one the plurality of discrete gripping regions comprises a surface of increased friction.

5. The tool of claim 2, wherein at least one the plurality of discrete gripping regions comprises a shoulder formed by a change in dimensions of the first and second frame members at the tips.

6. The tool of claim 1, further comprising a biasing member that normally biases the tips to a predetermined position.

7. The tool of claim 6, wherein the biasing member is a torsion spring that normally biases the tips to the open position.

8. The tool of claim 7, further comprising a first stopping feature that defines the closed position, wherein the tips do not contact one another in the closed position.

9. The tool of claim 8, further comprising a second stopping feature that defines the open position.

10. The tool of claim 9, further comprising a latch configured to secure the first and second frame members in the closed postion.

11. The tool of claim 10, wherein the latch is configured as the second stopping feature.

12. The tool of claim 1, wherein the cross sectional width is between 0.01625 inches and 0.25 inches.

13. The tool of claim 1, wherein the cross sectional width is between 0.03125 inches and 0.20 inches.

14. The tool of claim 1, further comprising a coating on the handles.

15. The tool of claim 1, further comprising a latch configured to secure the first and second frame members in the closed position.

16. An insertion and extraction tool for a fiber optic connector, comprising:
a first frame member;
second frame member; and
a pivot connection securing the first and second frame members to one another for movement between an open position and a closed position, the first and second frame members defining tips at one side of the pivot connection, the tips defining a plurality of discrete gripping regions,
wherein each of the plurality of discrete gripping regions is configured to pull to extract and push to install the fiber optic connector.

17. The tool of claim 16, wherein the plurality of discrete gripping regions comprises three regions.

18. The tool of claim 16, further comprising a biasing member that normally biases the tips to the open position.

19. An insertion and extraction tool for a fiber optic connector, comprising:
a first frame member;
second frame member;
a pivot connection securing the first and second frame members to one another for movement between an open position and a closed position; and
a biasing member that normally biases the tips to the open position,
the first and second frame members defining tips at one side of the pivot connection and handles at an opposite side of the pivot connection,
wherein the first and second frame members at least at the tips have a cross sectional width between 0.03125 inches and 0.20 inches,
wherein the first and second frame members are configured so that the tips define a plurality of discrete gripping regions, and
wherein each of the plurality of discrete gripping regions is configured to pull to extract and push to install the fiber optic connector.

20. The tool of claim 18, wherein the plurality of discrete gripping regions comprises three regions.
